(19) United States
(12) Patent Application Publication
(10) Pub. No.: US 2015/0363004 A1
(43) Pub. Date: Dec. 17, 2015

(54) IMPROVED TRACKING OF AN OBJECT FOR CONTROLLING A TOUCHLESS USER INTERFACE

(71) Applicant: CRUNCHFISH AB, Malmö (SE)

(72) Inventors: Paul CRONHOLM, Malmö (SE); Örjan JOHANSSON, Lund (SE)

(73) Assignee: CRUNCHFISH AB, Malmö (SE)

(21) Appl. No.: 14/761,664

(22) PCT Filed: Jan. 22, 2014
(86) PCT No.: PCT/SE2014/050070

§ 371 Date: Jul. 17, 2015

(30) Foreign Application Priority Data
Jan. 22, 2013 (SE) 1350064-0

(51) Int. Cl. G06F 3/01; H04N 5/225; H04N 5/232

(52) U.S. Cl. CPC G06F 3/017; H04N 5/23229; H04N 5/2256

(57) ABSTRACT

A computing device (100, 200)comprising a display (120) and a controller (210), wherein said controller (210) is configured to detect and track an object (H) via a video stream (265) provided by a camera (160, 260) and adapt an illumination (IL1, IL2, IL3) of said display (120) to properly illuminate the object (H) for successfully tracking said object (H).

### TECHNICAL FIELD

This application relates to a method, a computer-readable medium and a device for providing improved tracking of an object, and in particular to a method, a computer-readable medium and a device for an improved tracking of an object for controlling a touchless user interface.

### BACKGROUND

Touchless user interfaces have been known since the late 1990s and many solutions have been proposed for how to track an object. Some examples of such systems are given below.

The American patent application published as US2010294938A discloses an infrared sensing assembly for allowing detection of a location of an external object, as well as a mobile device employing such an assembly and related methods of operation, among other things, are disclosed. In one exemplary embodiment, the sensing assembly includes a pyramid-type housing structure having a central surface and multiple outer surfaces each of which extends in an inclined manner away from the central surface. The sensing assembly further includes multiple photo transmitters each positioned proximate to a respective one of the outer surfaces, and a photo receiver positioned proximate to the central surface, with each respective photoelectric device being oriented so as to correspond to its respective surface. The sensing assembly is operated so that light is emitted from the photo transmitters, reflected by the object, and received by the photo receiver. By processing signals from the photo receiver that are indicative of the received light, the external object's location is determined.

A disadvantage is that the illumination requires special photo transmitters which are both costly and difficult to incorporate in a small device.

Especially with cameras operating in the visible light spectrum, the use of special photo transmitters, lamps, carries disadvantages as the light provided may blind or at least disturb a user. The solution provide for by the prior art is to use Infra red photo transmitters, however, these transmitters still suffer from the problem that they are costly and difficult to incorporate into (especially small) devices.

There is thus a need for a computing device that is capable of tracking an object in low light conditions that does not come at an increased cost and is easy to incorporate also in small devices.

### SUMMARY

It is an object of the teachings of this application to overcome the problems listed above by providing a computing device comprising a display and a controller, wherein said controller is configured to detect and track an object via a video stream provided by a camera and adapt an illumination of said display to properly illuminate the object for successfully tracking said object.

Such a computing device is enabled to properly illuminate an object to be tracked without requiring any additional photo transmitters.

In one embodiment the controller is further configured to detect a distance to the object to be tracked and to adapt said illumination of said display based on said distance.

In one embodiment the controller is further configured to detect a surrounding light condition and to adapt said illumination of said display based on said surrounding light condition.

In one embodiment the controller is further configured to determine that the object is not possible to track under a current light conditions and in response thereto adapt said illumination of said display.

In one embodiment, the computing device is a mobile communications terminal. In one embodiment, the computing device is an internet tablet or a (laptop) computer. In one embodiment, the computing device is a game console. In one embodiment, the computing device is a media device such as a television set or media system.

It is also an object of the teachings of this application to overcome the problems listed above by providing a method for use in a computing device comprising a display, said method comprising detecting and tracking an object via a video stream provided by a camera and adapting an illumination of said display to properly illuminate the object for successfully tracking said object.

It is a further object of the teachings of this application to overcome the problems listed above by providing a computer readable medium comprising instructions that when loaded into and executed by a controller, such as a processor, in a computing device cause the execution of a method according to herein.

The inventors of the present invention have realized, after inventive and insightful reasoning that by utilizing a camera designed to operate in the visible light spectrum, the surrounding light is beneficially used to illuminate the object. Furthermore, and most importantly by coming to the realization that the illumination provided by an (active) display is part of the surrounding light and can as such be used to illuminate the object the need for specific additional lamps is mitigated. Furthermore to come to this inventive insight, the inventors overcame the prevalent consensus in the field that to reduce power consumption the illumination of the display is to be reduced in dark surroundings as the lighting needed to display the content discernibly compared to a bright environment is reduced. Furthermore, there is a strong bias in the field against using a strong illumination in a dark surrounding in that a brightly illuminated display reduces a user's night vision.

The manner taught herein thus provides a simple solution to a long-standing problem that is contrary to the prevailing prejudice regarding display illumination.

The teachings herein find use in control systems for devices having user interfaces such as mobile phones, smart phones, tablet computers, computers (portable and stationary), gaming consoles and media and other infotainment devices.

It is a further object of the teachings of this application to overcome the problems listed above by providing a computing device comprising a display and a controller, wherein said controller is configured to connect with a media device, detect an initiating event and in response thereto activate a camera, detect and track an object via a video stream provided by said camera, determine whether an object may be successfully tracked in a present light environment, and, if not so, adapt an illumination of said display to properly illuminate the object for successfully tracking said object.

It is a further object of the teachings of this application to overcome the problems listed above by providing a method for use in a computing device comprising a display, said method comprising connecting with a media device, detecting an initiating event and in response thereto activating a camera, detecting and tracking an object via a video stream provided by said camera, determining whether an object may be successfully tracked in a present light environment, and, if not so, adapting an illumination of said display to properly illuminate the object for successfully tracking said object.

This has the benefit that a media device can easily be controlled using a computing device using touchless control gestures even in dark environments.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein.

All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

The invention will be described in further detail under reference to the accompanying drawings in which:

FIGS. 1A, 1B and 1C are schematic views of each a computing device according to the teachings herein;

FIG. 2 is a schematic view of the components of a computing device according to the teachings herein;

FIG. 3 is a schematic view of a computer-readable memory according to the teachings herein;

FIGS. 4A, 4B and 4C show an example embodiment of a computing device according to the teachings herein;

FIG. 5 shows a flowchart illustrating a general method according to an embodiment of the teachings herein;

FIGS. 6A and 6B are schematic views of each a media device according to the teachings herein;

FIG. 7 shows an example embodiment of a computing device in a media system according to the teachings herein;

FIGS. 8A, 8B, 8C and 8D show an example embodiment of the operation of a computing device arranged to operate as a remote control according to the teachings herein;

FIG. 9 shows a flowchart illustrating a general method according to an embodiment of the teachings herein.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

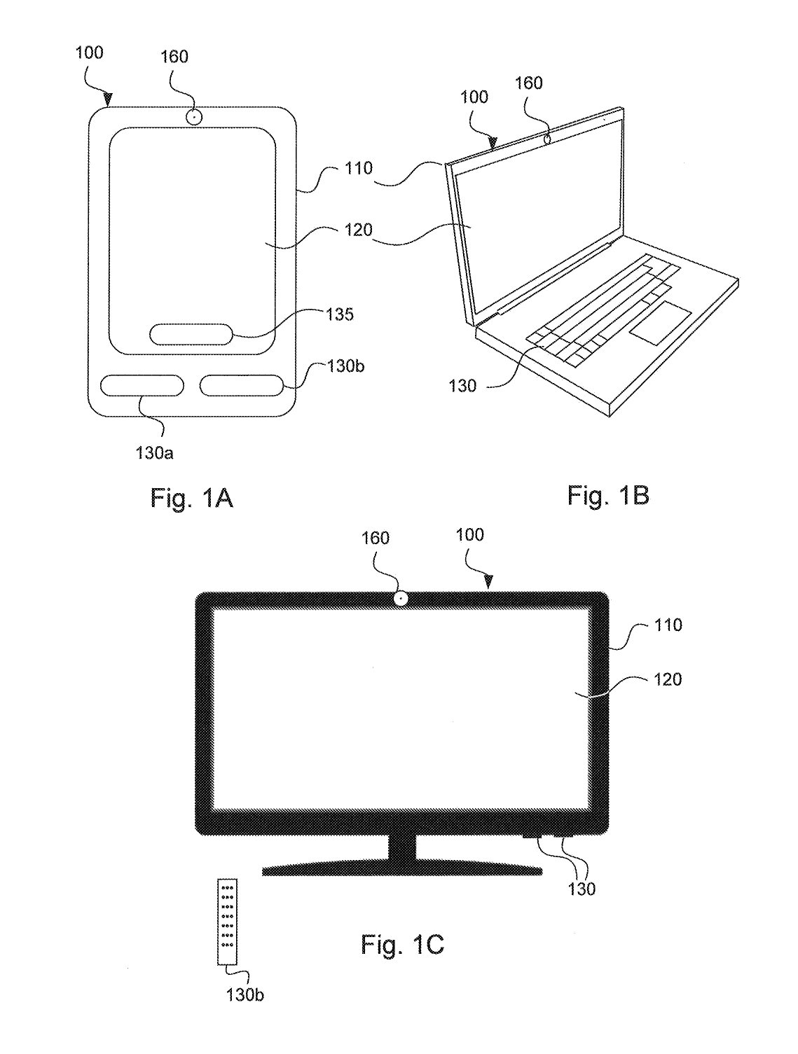

FIG. 1 generally shows a computing device 100 according to an embodiment herein. In one embodiment the computing device 100 is configured for network communication, either wireless or wired. Examples of a computing device 100 are: a personal computer, desktop or laptop, an internet tablet, a mobile communications terminal such as a mobile telephone, a smart phone, a personal digital assistant and a game console. Three embodiments will be exemplified and described as being a smartphone in FIG. 1A, a laptop computer 100 in FIG. 1B and a media device 100 in FIG. 1C. A media device is considered to be a computing device in the context of this application in the aspect that it is configured to receive digital content, process or compute the content and present the resulting or computed media, such as image(s) and/or audio.

Referring to FIG. 1A a mobile communications terminal in the form of a smartphone 100 comprises a housing 110 in which a display 120 is arranged. In one embodiment the display 120 is a touch display. In other embodiments the display 120 is a non-touch display. Furthermore, the smartphone 100 comprises two keys 130a, 130b. In this embodiment there are two keys 130, but any number of keys is possible and depends on the design of the smartphone 100. In one embodiment the smartphone 100 is configured to display and operate a virtual key 135 on the touch display 120. It should be noted that the number of virtual keys 135 are dependant on the design of the smartphone 100 and an application that is executed on the smartphone 100. The smartphone 100 is also equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

Referring to FIG. 1B a laptop computer 100 comprises a display 120 and a housing 110. The housing comprises a controller or CPU (not shown) and one or more computer-readable storage mediums (not shown), such as storage units and internal memory. Examples of storage units are disk drives or hard drives. The laptop computer 100 further comprises at least one data port. Data ports can be wired and/or wireless. Examples of data ports are USB (Universal Serial Bus) ports, Ethernet ports or WiFi (according to IEEE standard 802.11) ports. Data ports are configured to enable a laptop computer 100 to connect with other computing devices or a server.

The laptop computer 100 further comprises at least one input unit such as a keyboard 130. Other examples of input units are computer mouse, touch pads, touch screens or joysticks to name a few.

The laptop computer 100 is further equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

Referring to FIG. 1C a media device, such as a television set, TV, 100 comprises a display 120 and a housing 110. The housing comprises a controller or CPU (not shown) and one or more computer-readable storage mediums (not shown), such as storage units and internal memory, for storing user settings and control software. The computing device 100 may further comprise at least one data port (not shown). Data ports can be wired and/or wireless. Examples of data ports are USB (Universal Serial Bus) ports, Ethernet ports or WiFi (according to IEEE standard 802.11) ports. Such data ports are configured to enable the TV 100 to connect with an external storage medium, such as a USB stick, or to connect with other computing devices or a server.

The TV 100 may further comprise an input unit such as at least one key 130 or a remote control 130b for operating the TV 100.

The TV 100 is further equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

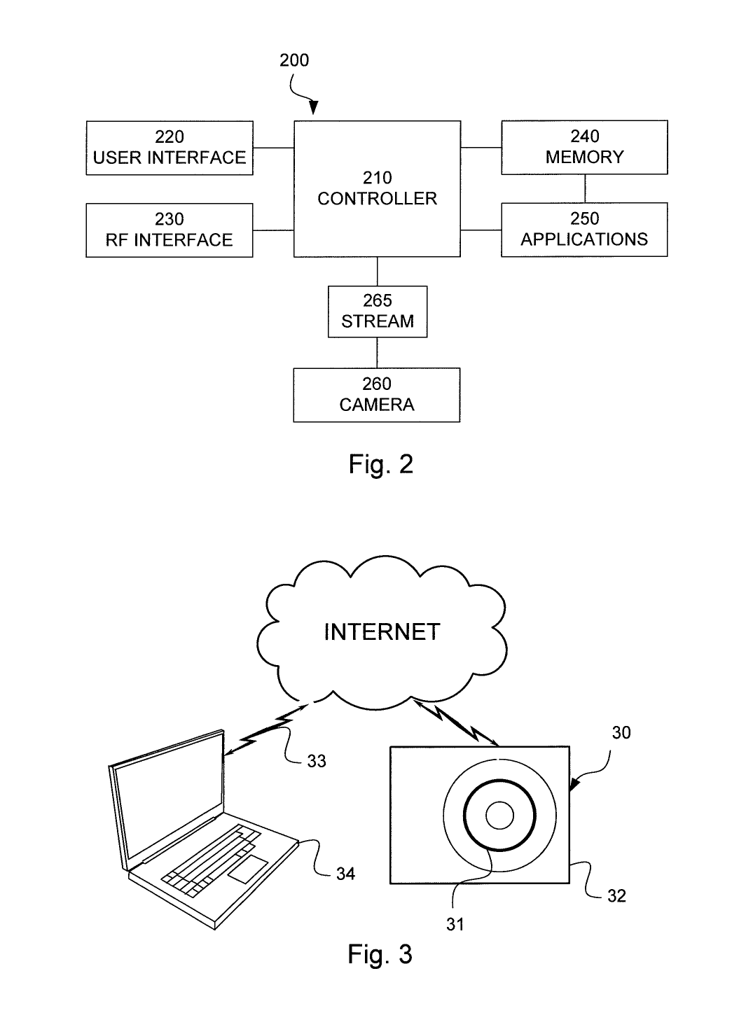

FIG. 2 shows a schematic view of the general structure of a device according to FIG. 1. The device 100 comprises a controller 210 which is responsible for the overall operation of the computing device 200 and is preferably implemented by any commercially available CPU (“Central Processing Unit”), DSP (“Digital Signal Processor”) or any other electronic programmable logic device. The controller 210 is configured to read instructions from the memory 240 and execute these instructions to control the operation of the computing device 100. The memory 240 may be implemented using any commonly known technology for computer-readable memories such as ROM, RAM, SRAM, DRAM, CMOS, FLASH, DDR, SDRAM or some other memory technology. The memory 240 is used for various purposes by the controller 210, one of them being for storing application data and program instructions 250 for various software modules in the computing device 200. The software modules include a real-time operating system, drivers for a user interface 220, an application handler as well as various applications 250.

The computing device 200 further comprises a user interface 220, which in the computing device of FIGS. 1A, 1B and 1C is comprised of the display 120 and the keys 130, 135.

The computing device 200 may further comprises a radio frequency interface 230, which is adapted to allow the computing device to communicate with other devices through a radio frequency band through the use of different radio frequency technologies. Examples of such technologies are IEEE 802.11, IEEE 802.15, ZigBee, WirelessHART, WIFI, Bluetooth®, W-CDMA/HSPA, GSM, UTRAN and LTE to name a few.

The computing device 200 is further equipped with a camera 260. The camera 260 is a digital camera that is arranged to take video or still photographs by recording images on an electronic image sensor (not shown).

The camera 260 is operably connected to the controller 210 to provide the controller with a video stream 265, i.e. the series of images captured, for further processing possibly for use in and/or according to one or several of the applications 250.

In one embodiment the camera 260 is an external camera or source of an image stream.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 3 shows a schematic view of a computer-readable medium as described in the above. The computer-readable medium 30 is in this embodiment a data disc 30. In one embodiment the data disc 30 is a magnetic data storage disc. The data disc 30 is configured to carry instructions 31 that when loaded into a controller, such as a processor, executes a method or procedure according to the embodiments disclosed above. The data disc 30 is arranged to be connected to or within and read by a reading device 32, for loading the instructions into the controller. One such example of a reading device 32 in combination with one (or several) data disc(s) 30 is a hard drive. It should be noted that the computer-readable medium can also be other mediums such as compact discs, digital video discs, flash memories or other memory technologies commonly used.

The instructions 31 may also be downloaded to a computer data reading device 34, such as a laptop computer or other device capable of reading computer coded data on a computer-readable medium, by comprising the instructions 31 in a computer-readable signal 33 which is transmitted via a wireless (or wired) interface (for example via the Internet) to the computer data reading device 34 for loading the instructions 31 into a controller. In such an embodiment the computer-readable signal 33 is one type of a computer-readable medium 30.

The instructions may be stored in a memory (not shown explicitly in FIG. 3, but referenced 240 in FIG. 2) of the laptop computer 34.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

An improved manner of tracking an object will be disclosed below with reference to the accompanying figures. The example will be illustrated focusing on the resulting illumination provided by a display, but it should be clear that the processing is performed in part or fully in a computing device comprising a controller as disclosed above with reference to FIGS. 1 and 2 or caused to be performed by executing instructions stored on a computer-readable medium as disclosed with reference to FIG. 3.

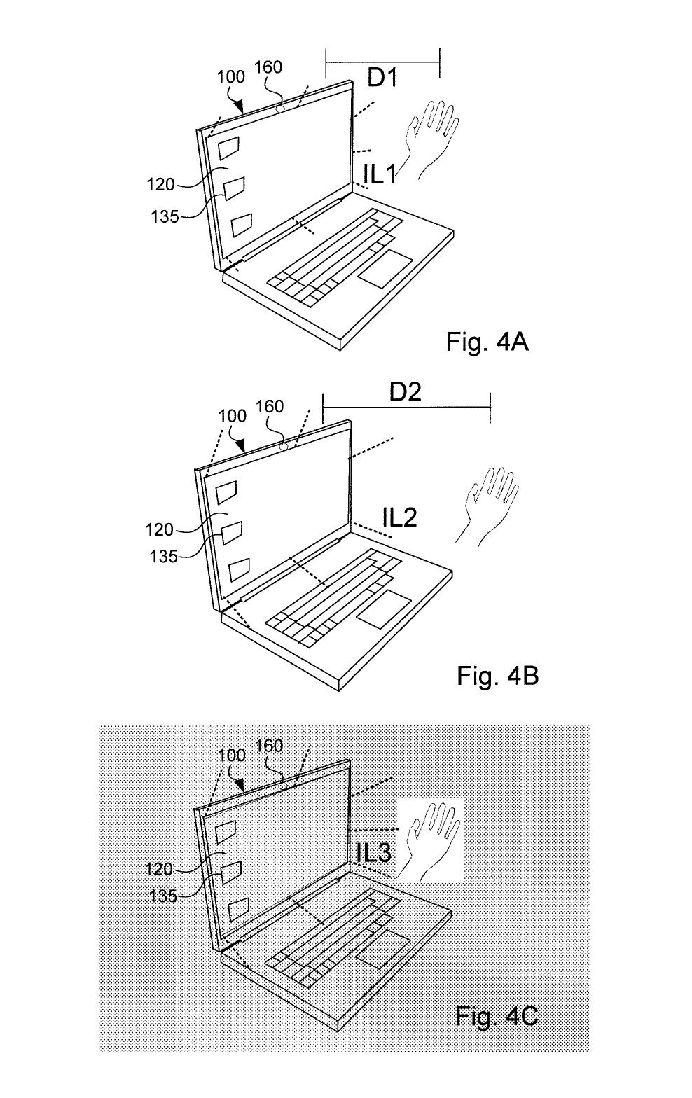

FIG. 4A shows an example of a computing device, in this example a laptop computer 100 as in FIG. 1B, that is configured to detect and track an object, such as a hand H, via a video stream provided by a camera (160). The laptop computer 100 has a display 120 on which objects 135 are displayed. The display is set to radiate or be illuminated at an initial (or normal) level. In FIG. 4A the initial illumination is indicated with the dashed lines and referred to as IL1. The initial level of illumination depends on a number of factors as would be apparent to a skilled person and may also be user configurable.

In FIG. 4A the hand is at a distance D1 from the display. In the example of FIG. 4A it is assumed that the surrounding light condition is bright enough to properly illuminate the hand H well enough for the camera and the controller using the associated computer instructions to track the hand H. How such an object H is detected and tracked is disclosed in the Swedish patent application SE 1250910-5 and will not be discussed in further detail in the present application. For further details on this, please see the mentioned Swedish patent application. It should be noted, however, that the teachings of the present application may be implemented through the use of other tracking manners than disclosed in Swedish patent application SE 1250910-5.

In the example of FIGS. 4A and 4B the surrounding light condition is not sufficient for successfully track a detected object, such as the hand H, when the hand H is placed at a greater distance, such as distance D2, from the display 120.

In one embodiment the laptop computer 100 is configured to detect that object is present in front of the display 120/camera 160 by analyzing the image stream provided.

One manner of detecting an object relies on the fact that an object to be tracked is most likely not statically positioned in front of the camera 160 and movement can thus be detected in that there are changes between the images in the image stream making up the video stream.

As the controller only needs to detect changes to determine that there is movement of an object and thereby detect an object (as being the area where the changes are detected) the light required may be less than required to actually track an object. When tracing an object more details on the object are needed to determine how the object moves and that it is the object that is being tracked that is actually moving.

Some factors influence how well an object may be detected. Examples of such factors are color, reflection and structure (sharp and regular edges) of the object. For example, it is easier to detect a white object, than a black object in a poorly lit room.

As it becomes impossible to track the object H using the illumination provided by the surrounding the light conditions, the laptop computer 100 is configured to adapt the illumination of the display 120 to increase the illumination and thereby the surrounding light to better illuminate the hand H and enable successful tracking of the object.

Referring to FIG. 4B the laptop computer 100 is configured to detect that the hand H is at a distance D2 from the display and in response thereto adapt the illumination of the display 120. In FIG. 4B this is indicated by longer dashed lines emanating from the display 120 and the increased illumination is referenced IL2.

By increasing the illumination of the display the surrounding light condition is improved and the laptop computer 100 is able to successfully track the hand H for receiving control input as part of the user interface of the laptop computer 100.

For the example of FIGS. 4A and 4B the controller detects that the hand H is moved away from the display 120 and in response thereto increases the illumination of the display 120.

Referring to FIG. 4C the laptop computer 100 is configured to detect that the hand H is detectable but not trackable and in response thereto adapt the illumination of the display 120. This determination may be made by measuring the surrounding light condition, for example by analyzing the video stream provided by the camera 160. In FIG. 4B this is indicated by longer dashed lines emanating from the display 120 and the increased illumination is referenced IL2.

For the example of FIGS. 4A and 4C the display 120 is initially at a first (initial) illumination IL1 (FIG. 4A) either it is determined (as explained above) that the illumination is not sufficient or the surrounding light conditions change to become insufficient. FIG. 4C illustrates the insufficient light condition by being shaded. The laptop computer 100 is configured to detect that the light condition is not sufficient and in response thereto increase the illumination of the display 120. In FIG. 4C this is indicated by longer dashed lines emanating from the display 120 and the increased illumination is referenced IL3.

In one embodiment the laptop computer 100 is configured to determine that the object is not trackable by unsuccessfully trying to carry out a tracking operation and in response thereto increase the illumination of the display 120. Such tracking operations are disclosed in, but not limited to, the Swedish patent application SE 1250910-5 and will not be discussed in further detail in the present application.

In one embodiment the laptop computer 100 is thus configured to detect an object and determine that the object is not possible to track under the current light conditions (possibly using the initial illumination IL1), based at least on one of measuring the surrounding light condition, detecting a distance and/or determining that a tracking operation is unsuccessful and in response thereto increase the illumination of the display 120.

In one embodiment the laptop computer 100 is configured to adjust the illumination of the display 120 stepwise or linearly until and/or while the object to be tracked is able to be successfully tracked, for example by adjusting the illumination of the display 120 so that the object is clearly discernible, which may be determined through analysis of the image(s) in the video stream.

It should be noted that even though the adaption based on light condition and the adaption based on distance is disclosed separately in the above, the two may be combined into an adaption based on both the distance and the light condition. The adaptation based on determining whether the object to be tracked is trackable may also be combined with the adaptation based on distance, the adaptation based on light condition or the combination of them.

As mentioned above the discernibleness of an object depends on a number of factors. In one embodiment the laptop computer 100 is configured to store an appearance profile for a user's preferred control object or object to be tracked. Such as the user's hand or finger. The factors stored may relate to color, reflective characteristics, and or structure. By having access to information on the object to be tracked and how easily it may be discerned the illumination level, possibly the initial illumination level, may be adapted to enable a successful detection and tracking of an object without having to determine a suitable illumination level by trial and error. This can be performed for example when a new user logs on to or is detected by the computing device.

The stored appearance profile may differ depending on the surrounding light condition and the laptop computer 100 may be configured to take the surrounding light condition into account when determining the initial illumination level (IL1).

In one embodiment the laptop computer 100 is configured to illuminate the display 120 at the increased illumination level IL2, IL3 for a first time period and after the first time period has lapsed, illuminate the display 120 at the initial illumination level IL1. Examples of the first time period are in the range of 1 to 10 seconds, 1 to 5 seconds, 1 second, 2 seconds or 3 seconds.

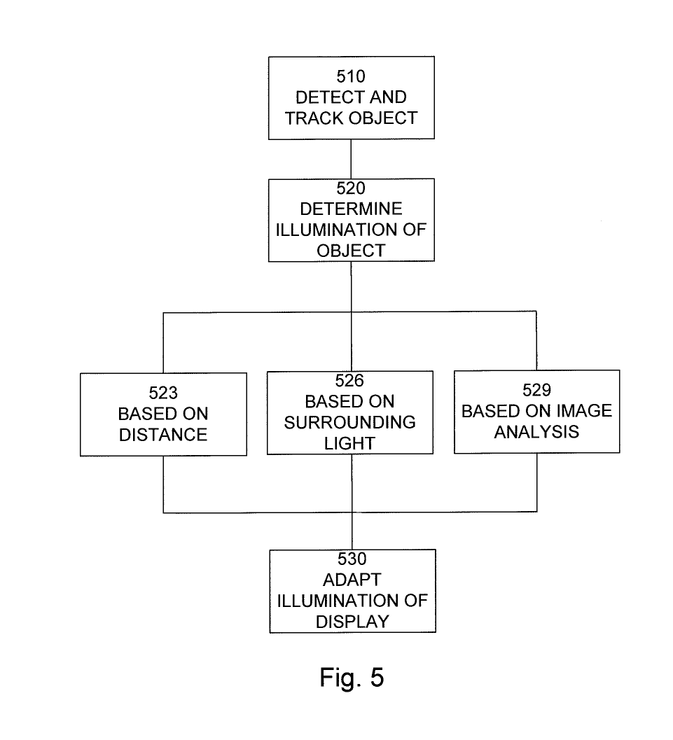

FIG. 5 shows a flowchart of a general method according to the teachings herein. A computing device detects and tracks 510 an object, such as a hand. The computing device determines that an object is insufficiently illuminated 520 and in response thereto adapts the illumination of the display 530. The illumination of the object may be determined based on the distance 523, the surrounding light condition 526 or an image analysis of the detected object 529.

The invention thus teaches that the computing device may utilize the illumination added to the light condition by the display to ensure that the illumination of the object to be tracked is sufficient to track the object and to adapt the illumination accordingly.

The teachings herein provide the benefit that an object may be tracked even under poorly lit conditions and without requiring costly equipment.

Another benefit lies in that the teachings herein may even be implemented in existing devices by a software upgrade.

A modern home often has many media devices such as stereos, radios, TVs etc all having one remote each. Several solutions have been proposed on how to use universal remote controls for these media devices to reduce the number of remote controls. Also, some suggestions have been made of using smartphones and PDAs as remote controls, also being able to control more than one media device. This is beneficial in many circumstances, but suffers from problems such as how a media device out of a plurality is to be selected.

Furthermore, using touchless control in contemporary computing devices suffers from the drawbacks that the user has to somehow activate the device manually. Also, the computing device will have to be able to operate in ark environments as many user will prefer to enjoy their media devices in poorly lit environments.

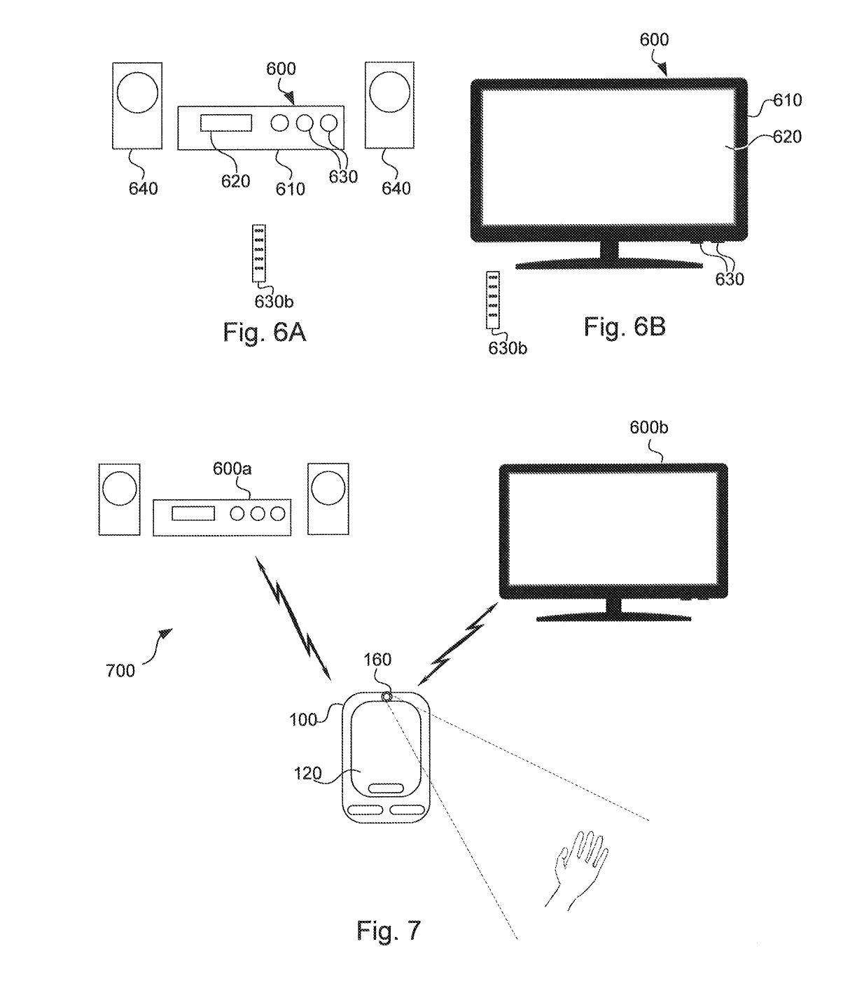

FIGS. 6A and 6B are schematic views of each a media device according to the teachings herein which can be controlled by a computing device 100 according to herein in a manner aimed at overcoming the drawbacks and problems listed above.

Referring to FIG. 6A a media device being a television set, TV, 600 will be described and referring to FIG. 6B a media device being an audio set 600 will be described. Such a media device 600 comprises a display 620 and a housing 610. The housing comprises a controller or CPU (not shown) and one or more computer-readable storage mediums (not shown), such as storage units and internal memory, for storing user settings and control software. The media device 600 may further comprise at least one data port (not shown). Data ports can be wired and/or wireless. Examples of data ports are USB (Universal Serial Bus) ports, Ethernet ports or WiFi (according to IEEE standard 802.11) ports. Such data ports are configured to enable the media device 600 to connect with an external storage medium, such as a USB stick, or to connect with other computing devices or a server. A wireless dataport is used to connect with a computing device 100 for receiving control information from the computing device 100, thereby enabling the computing device 100 to act as a remote for the media device 600.

The media device 600 may further comprise an input unit such as at least one key 630 or a remote control 630b for operating the TV 600 or audio set 600. The media device 600 may also comprise a set of loud speakers 640.

FIG. 7 shows an example embodiment of a computing device 100 in a media system 700 according to the teachings herein. The example media system 700 of FIG. 7 comprises one audio set 600a and one TV 600b, but it should be noted that any number of media devices 600 may be part of the media system 700. A computing device 100 is wirelessly connected to at least one of the media devices 600a, 600b as is indicated by the dashed arrow. One possibility is to connect the computing device 100 to a media device through a Blutooth™ interface or a radio frequency interface according to the IEEE 802.11 (WiFi) standard.

The computing device 100 is arranged with a camera 160, as has been discussed in the above, for detecting and tracking an object for identifying control gestures, which gestures can be used to control any or all of the media devices 600a, 600b. The controller (not shown) of the computing device 100 detects and identifies a gesture, determines a corresponding action or function and sends a control command to a related media device 600a, 600b for controlling the media device 600a, 600b. In FIG. 7 a hand is detected and tracked. The gesture or the object performing the gesture may be specific to a media device which will enable the computing device to also determine which media device the control gesture is aimed for. For example, to control a media device 600 placed on a user's right hand side, the user uses his right hand, and to control a media device placed on a user's left side, the user uses his left hand. The computing device will thus be able to also identify which media device that is to be controlled from the detected gesture and/or from the detected object to be tracked.

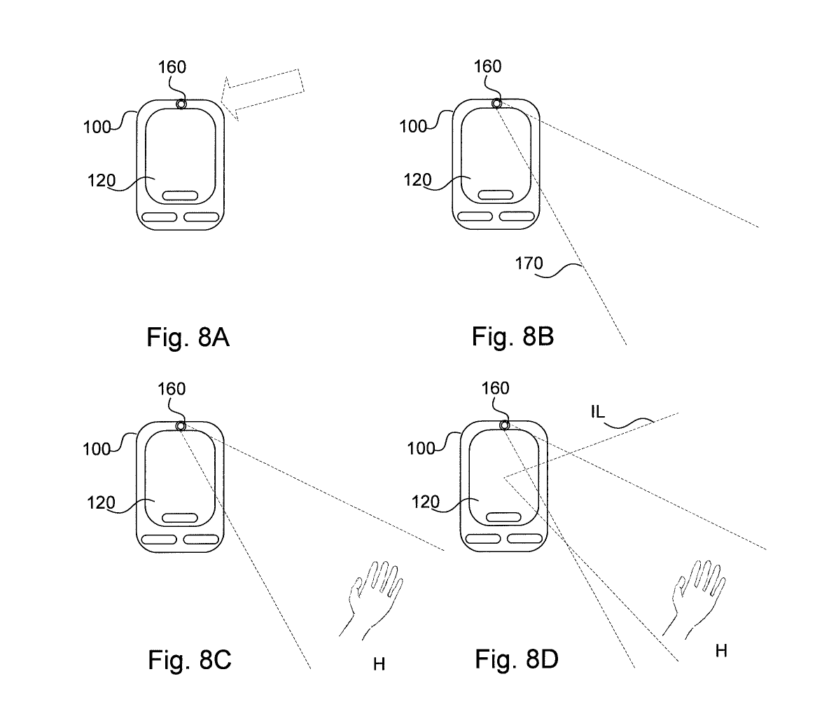

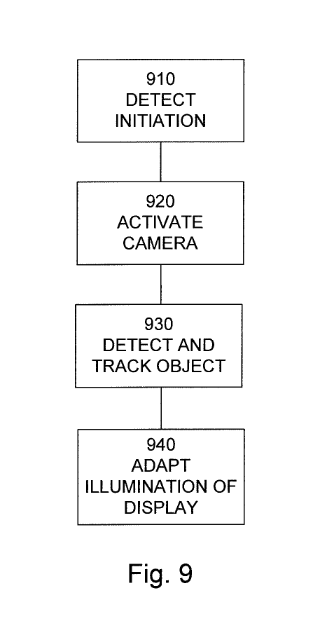

FIGS. 8A, 8B, 8C and 8D show an example embodiment of the operation of a computing device 100 arranged to operate as a remote control according to the teachings herein. The operation will be described with simultaneous reference to FIG. 9 which shows a flowchart illustrating a general method according to an embodiment of the teachings herein. The computing device 100 is arranged to detect an initiating event 910, such as a knock or tap, or possibly a key press. The use of a knock or tap on the computing device 100 enables for a simpler activation of the computing device 100. Also possible initiation events are loud sounds (such as hand claps or banging on a table surface) or possibly a shaking motion, such as when banging or clapping on a surface on which the computing device 100 is placed. Such initiating events are useful as a user does not need to touch the computing device 100 to initiate the control of a media device 600. In FIG. 8A the initiating event is indicated by a dashed arrow.

In response to the detection of the initiating event, the computing device 100 activates 920 the camera 160, which in FIG. 8B is illustrated by a viewing cone 170 being indicated. The computing device 100 further detects and tracks 930 an object H that appears in the viewing cone 170. The computing device 100 is further configured to determine whether the object H is properly illuminated to ensure a successful tracking. The determination can be made both using the camera 160 and/or using a light detector such as an ALS (Ambient Light Sensor). The computing device 100 may be configured to determine an overall or present light environment and determine whether it is too dark to properly track an object, such as a hand H. The computing device 100 may also or alternatively be configured to determine that an object is not properly tracked and in response thereto determine that the object is not properly illuminated. One example of such a situation is when the computing device 100 is unable to identify specific features of the object, also called descriptors. Examples of such descriptors and how they are identified and processed can be found in the Swedish patent application SE 1250910-5 and will not be discussed herein in further detail.

The computing device 100 is further configured to adapt the brightness 940 of the display 120 in order to more properly illuminate the tracked object. The brightness may thus be increased to more properly illuminate the tracked object enabling a more successful tracking. In FIG. 8D this is illustrated by an increased illumination IL.

The computing device 100 may also be configured to detect a distance to the tracked object H and detect a change in the distance and in response thereto adapt the illumination of the display as has been disclosed in the above.

It should be noted that by realizing that the display 120 can be used for illumination in dark environment, which goes against contemporary teaching that a display should be darkened when in a dark environment to save power, an illumination can be achieved that requires no additional hardware.

The adaptation of the illumination may be performed both before and after a tracked object has been detected and may also be done repeatedly.

This has the benefit that a computing device 100 may easily be used as a remote control for a media device 600 without user touch and even in dark environments where touchless control may otherwise be impossible and this without requiring any additional hardware, thereby making the manner herein possible to implement in already existing hardware through a simple software upgrade.

The invention has mainly been described above with reference to a few embodiments. However, as is readily appreciated by a person skilled in the art, other embodiments than the ones disclosed above are equally possible within the scope of the invention, as defined by the appended patent claims.

1-15. (canceled)

16. A computing device (100, 200) comprising a display (120) and a controller (210), wherein said controller (210) is configured to:
detect and track an object (H) via a video stream (265) provided by a camera (160, 260) and adapt an illumination (IL1, IL2, IL3) of said display (120) to illuminate the object (H) so that said computing device (100, 200) is enabled to successfully detect and track said object (H), wherein said controller (210) is further configured to detect a distance (D1, D2) to the object to be tracked (H) and to adapt said illumination (IL1, IL2, IL3) of said display (120) based on said distance (D1, D2) so that if the controller detects an increased distance, the illumination is increased, wherein said illumination is provided by radiation of the display (120).

17. The computing device (100, 200) according to claim 16, wherein said controller (210) is further configured to detect a surrounding light condition
and to adapt said illumination (IL1, IL2, IL3) of said display (120) based on said surrounding light condition.

18. The computing device (100, 200) according to claim 16, wherein said controller (210) is further configured to determine that the object (H) is not possible to track under a current light conditions and in response thereto adapt said illumination (IL1, IL2, IL3) of said display (120).

19. The computing device (100, 200) according to claim 18, wherein said controller (210) is further configured to dynamically adapt said illumination (IL1, IL2, IL3) of said display (120) until the object (H) is clearly discernible.

20. The computing device (100, 200) according to claim 16 further comprising a memory (240), and wherein said controller (210) is further configured to store an appearance profile for a known object to be tracked in said memory and adapt said illumination (IL1, IL2, IL3) of said display (120) based on said stored appearance profile.

21. The computing device (100, 200) according to claim 20, wherein said stored appearance profile is associated with a surrounding light condition.

22. The computing device (100, 200) according to claim 16, wherein said controller (210) is further configured to illuminate said display (120) at an adapted illumination level (IL2, IL3) for a first time period and after the first time period has lapsed, illuminate the display (120) at an initial illumination level (IL1).

23. A method for use in a computing device (100, 200) comprising a display (120), said method comprising:
detecting and tracking an object (H) via a video stream (265) provided by a camera (160, 260) and adapting an illumination (IL1, 1L2, IL3) of said display (120) to illuminate the object (H) so that said computing device (100, 200) is enabled to successfully track and detect said object (H), wherein said method further comprises detecting a distance (D1, D2) to the object to be tracked (H) and adapting said illumination (IL1, IL2, IL3) of said display (120) based on said distance (D1, D2) so that if an increased distance is detected, the illumination is increased, wherein said illumination is provided by radiation of the display (120).

24. A computing device (100, 200) comprising a display (120) and a controller (210), wherein said controller (210) is configured to:
connect with a media device (600);
detect an initiating event and in response thereto
activate a camera (160, 260);
detect and track an object (H) via a video stream (265) provided by said camera (160, 260);
determine whether an object may be successfully tracked in a present light environment, and, if not so, adapt an illumination (IL) of said display (120) to illuminate the object (H) so that said computing device (100, 200) is enabled to successfully track and detect said object (H), wherein said illumination is provided by radiation of the display (120).

25. The computing device (100, 200) according to claim 24, wherein said controller (210) is further configured to determine whether an object may be successfully tracked in a present light environment using an ambient light sensor.

26. The computing device (100, 200) according to claim 24, wherein said controller (210) is further configured to identify a gesture performed by said tracked object (H), identify, a corresponding action and sends a control command to said media device (600).

27. The computing device (100, 200) according to claim 26, wherein said controller (210) is further configured to identify said media device based on said identified gesture.

28. The computing device (100, 200) according to claim 26, wherein said controller (210) is further configured to identify said media device based on said detected tracked object (H).

29. A method for use in a computing device (100, 200) comprising a display (120), said method comprising:
connecting with a media device (600);
detecting an initiating event and in response thereto
activating a camera (160, 260);
detecting and tracking an object (H) via a video stream (265) provided by said camera (160, 260);
determining whether an object may be successfully tracked in a present light environment, and, if not so, adapting an illumination (IL1) of said display (120) to illuminate the object (H) so that said computing device (100, 200) is enabled to successfully track and detect said object (H), wherein said illumination is provided by radiation of the display (120).

30. A computer readable storage medium (40) encoded with instructions (41) that, when loaded and executed on a processor, causes the method according to claim 23 to be performed.

31. The computing device (100, 200) according to claim 17, wherein said controller (210) is further configured to determine that the object (H) is not possible to track under a current light conditions and in response thereto adapt said illumination (IL1, IL2, IL3) of said display (120).

32. The computing device (100, 200) according to claim 17 further comprising a memory (240), and wherein said controller (210) is further configured to store an appearance profile for a known object to be tracked in said memory and adapt said illumination (IL1, IL2, IL3) of said display (120) based on said stored appearance profile.

33. The computing device (100, 200) according to claim 18 further comprising a memory (240), and wherein said controller (210) is further configured to store an appearance profile for a known object to be tracked in said memory and adapt said illumination (IL1, IL2, IL3) of said display (120) based on said stored appearance profile.

34. The computing device (100, 200) according to claim 19 further comprising a memory (240), and wherein said controller (210) is further configured to store an appearance profile for a known object to be tracked in said memory and adapt said illumination (IL1, IL2, IL3) of said display (120) based on said stored appearance profile.

35. The computing device (100, 200) according to claim 17, wherein said controller (210) is further configured to illuminate said display (120) at an adapted illumination level (IL2, IL3) for a first time period and after the first time period has lapsed, illuminate the display (120) at an initial illumination level (IL1).
